(19) United States
(12) Patent Application Publication
(10) Pub. No.: US 2015/0016337 A1
(43) Pub. Date: Jan. 15, 2015

(54) METHOD FOR CONFIGURING RADIO FRAMES AND APPARATUS USING THE METHOD

(71) Applicant: Electronics and Telecommunications Research Institute, Daejeon (KR)

(72) Inventors: Hee Sang CHUNG, Daejeon (KR); Il Gyu KIM, Chungcheongbuk-Do (KR)

(73) Assignee: Electronics and Telecommunications Research Institute, Daejeon (KR)

(21) Appl. No.: 14/256,170

(22) Filed: Apr. 18, 2014

(30) Foreign Application Priority Data
Apr. 18, 2013 (KR) 10-2013-0042856

(51) Int. Cl. H04J 3/06; H04W 56/00; H04L 27/26; H04W 72/04

(52) U.S. Cl. CPC H04J 3/0638; H04W 72/0446; H04W 56/001; H04L 27/2613
USPC 370/328

(57) ABSTRACT

Disclosed are a method for configuring a radio frame, an apparatus for the same, a method for a mobile terminal to acquire synchronization with a base station, and a mobile terminal for the same. A method for configuring a radio frame, according to an example embodiment of the present invention, comprises generating a first synchronization signal and arranging the first synchronization signal in a slot for synchronization signal, generating a second synchronization signal and arranging the second synchronization signal in a predetermined position from the first synchronization signal, and constructing a radio frame including the first synchronization signal and the second synchronization signal. A plurality of secondary synchronization signals include difference sequences derived from a same sequence, and constitute hopping code with a predetermined hamming distance.

### CLAIM FOR PRIORITY

This application claims priorities to Korean Patent Application No. 10-2013-0042856 filed on Apr. 18, 2013 in the Korean Intellectual Property Office (KIPO), the entire contents of which are hereby incorporated by references.

### BACKGROUND

1. Technical Field

Example embodiments of the present invention relate to a method for configuring radio frames, and more specifically to a method for generating a synchronization signal, a method for configuring radio frames, and a method of receiving radio frames and acquiring synchronization using the received radio frames.

2. Related Art

Mobile communication systems generally use carrier frequencies of several hundreds of megahertz (MHz) bands or several gigahertz (GHz) bands. For example, frequency bands of a Long-Term Evolution (LTE) system used in Korea are one of 850 MHz, 1.8 GHz, and 2.1 GHz. Similar frequency bands are used in other countries such as north America, Europe, Japan, China, etc.

Due to properties of used frequency bands, different frame structures and different channel structures may be used in a mobile communication system. For example, the LTE system adopts an Orthogonal Frequency Division Multiplexing (OFDM) as a downlink transmission scheme. A space between subcarriers is determined to be 15 kHz in order to use OFDM in the above described frequency bands. Accordingly, its inverse number 66.67 μs determined to be a length of one OFDM symbol. For reference, in the OFDM transmission scheme, a length of an OFDM symbol becomes an inverse number of a space between subcarriers.

Meanwhile, due to a world-wide situation that radio frequency resources used for mobile communication are being depleted, a method of utilizing millimeter-wave frequency bands is being focused upon while the millimeter frequency bands are being allocated as license-exempt bands in Japan, USA, Canada, and Europe as well as Korea. In addition to an advantage that the millimeter-wave frequency bands can be used world-widely without interferences from other wireless communication systems, the millimeter-wave frequency bands also have an advantage that it is easy to use contiguous frequency bands in the millimeter-wave frequency bands.

The frequency of millimeter-wave is ranged from 30 to 300 GHz, and is abbreviated to an Extremely High Frequency (EHF). The electromagnetic wave having a millimeter-wave length is in the middle of a currently-used radio frequency band and an infrared band (wave length under 0.1 mm), and is an electromagnetic wave having properties close to those of a light. Also, it is widely used for a high-resolution radar system and a microwave spectroscopy.

The electromagnetic wave in millimeter-wave band may be transmitted through a wire (a wave guide). Also, a wireless transmission through the atmosphere is possible except several narrow bands causing absorption by oxygen and moisture. The increase of carrier frequency may mean increase in amount of information transmitted, and the decrease of wavelength of electromagnetic wave may mean enhancement of directivity of the electromagnetic wave so that a size of antenna may be reduced and it becomes more convenient to carry the device equipped with the antenna. Also, the enhancement of directivity of the electromagnetic wave may prevent a leakage of the electromagnetic wave, and so the communication using the millimeter-wave frequency may be advantageous in secret communications.

In order to use the above-described millimeter-wave for mobile communication, there exist many technical problems to be solved in connection with transmission and reception apart from a problem related to a wireless channel. A structure of radio frames used for millimeter-wave mobile communications is one of the problems.

### SUMMARY

Accordingly, example embodiments of the present invention are provided to substantially obviate one or more problems due to limitations and disadvantages of the related art.

Example embodiments of the present invention provide a method of configuring radio frames.

Example embodiments of the present invention also provide a method of acquiring synchronization in a mobile terminal.

Example embodiments of the present invention also provide a method of generating a synchronization signal.

Example embodiments of the present invention also provide an apparatus using the method of configuring radio frames and the method of generating a synchronization signal.

Example embodiments of the present invention also provide a terminal using method of acquiring synchronization.

In some example embodiments, a method for configuring a radio frame used in a mobile communication system, the method may comprise generating a first synchronization signal and locating the first synchronization signal in a slot for synchronization signal; generating a second synchronization signal and locating the second synchronization signal in a predetermined position from the first synchronization signal; and configuring a radio frame including the first synchronization signal and the second synchronization signal, wherein the mobile communication system is a mobile communication system using a millimeter wave frequency band, and a distance between symbols used in the mobile communication system is one-tenth of a distance between symbols used in a Long Term Evolution (LTE) system.

Here, the primary synchronization signal and the secondary synchronization signal may be located in a symbol allocated for downlink, and located as not overlapped with a control channel.

Here, the primary synchronization signal and the secondary synchronization signal may be located in a symbol adjacent to a symbol for a broadcast channel.

Here, the secondary synchronization signal may be located in a previous symbol of a symbol in which the primary synchronization signal is located.

Here, the primary synchronization signal may be located in a last symbol of a slot in which the primary synchronization signal is located.

Here, a plurality of the primary synchronization signals located in a frame may include a same sequence.

Here, a plurality of the secondary synchronization signals located in a frame may be different to each other.

Here, a sequence for the primary synchronization signal and a sequence for the secondary synchronization signal may be transmitted through a half band of a synchronization signal band located in a center of the synchronization signal band, and transmitted with double power as compared to a case in which they are transmitted through the whole synchronization signal band.

Also, a plurality of secondary synchronization signal sequences included in a frame may be different sequences derived from a same sequence, and constitute hopping code with a predetermined hamming distance.

In other example embodiments, a method of acquiring synchronization, performed in a mobile terminal, the method may comprise receiving a radio frame including a plurality of time slots; detecting a first synchronization signal included in the radio frame by searching the radio frame; and detecting a second synchronization signal included in the radio frame, located with a predetermined distance from the first synchronization signal, wherein the radio frame is received from a mobile communication system using a millimeter wave frequency band, and a distance between symbols used in the mobile communication system is one-tenth of a distance between symbols used in a Long Term Evolution (LTE) system.

Here, the method may further comprise acquiring a slot boundary based on the detected primary synchronization signal, wherein the radio frame includes a plurality of subframes each of which includes a plurality of slots.

Here, the method may further comprise acquiring a radio frame boundary based on the detected secondary synchronization signal.

Here, the method may further comprise obtaining first cell information from the detected primary synchronization signal; obtaining second cell information from the detected secondary synchronization signal; and deriving a cell identity of a base station based on the first cell information and the second cell information.

Here, a plurality of secondary synchronization signal sequences included in a frame may be different sequences derived from a same sequence, and constitute hopping code with a predetermined hamming distance.

Also, the obtaining second cell information may comprise extracting a plurality of secondary synchronization signal sequences included in a plurality of secondary synchronization signals; comparing the extracted plurality of secondary synchronization signal sequences with a predefined hopping code table; and obtaining the second cell information according to a hopping code matched to the extracted plurality of secondary synchronization signal sequences.

Also, the hopping code table may include a plurality of hopping codes each of which corresponds to one of a plurality of second cell information.

Also, the extracting a plurality of secondary synchronization signal sequences may be performed for as many number of secondary synchronization signals as determined according to a hamming distance which the hopping codes included in the hopping code table have.

In other example embodiments, a method for generating a synchronization signal for a mobile communication, the method may comprise generating a first synchronization sequence by using a first cell information; and generating a second synchronization sequence by using a second cell information, wherein a plurality of second synchronization sequences included in a radio frame constitute a hopping code having a predetermined hamming distance.

Here, a plurality of secondary synchronization signal sequences included in a frame may be different sequences derived from a same sequence, and constitute hopping code with a predetermined hamming distance

Here, a plurality of the primary synchronization signal sequences included in a frame may be a same sequence.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a frame structure and a channel structure of an LTE system which is a conventionally used mobile communication system;

FIG. 2 is a view illustrating a structure of radio resources in the LTE system;

FIG. 3 is a view illustrating a structure of a synchronization signal in the LTE system;

FIG. 4 is a view illustrating an example embodiment of a frame structure used in a cellular communication system using an OFDM manner using millimeter-waves;

FIG. 5 is a view illustrating a frame structure according to another example embodiment of the present invention, in an OFDM mobile communication system using millimeter-waves;

FIG. 6 is a view illustrating a frame structure according to another example embodiment of the present invention, in an OFDM mobile communication system using millimeter-waves;

FIG. 7 is a view illustrating a synchronization signal in a radio frame according to an example embodiment of the present invention;

FIG. 8 is a view illustrating a detail structure of a synchronization signal according to an example embodiment of the present invention;

FIG. 9 is a view illustrating a structure of synchronization signal in a radio frame according to another example embodiment of the present invention;

FIG. 10 is a view illustrating a structure of synchronization signal in a radio frame according to another example embodiment of the present invention;

FIG. 11 and FIG. 12 are views illustrating detail structures of synchronization signals according to another example embodiment of the present invention;

FIG. 13 and FIG. 14 are views illustrating detail structures of synchronization signals according to another example embodiment of the present invention;

FIGS. 15A to 15C are views illustrating example embodiments of hopping codes satisfying a hamming distance of 8;

FIGS. 16A to 16C are views illustrating example embodiments of hopping codes satisfying a hamming distance of 4;

FIGS. 17A to 17C are views illustrating another example embodiment of hopping codes satisfying a hamming distance of 4;

FIG. 18 is a flow chart illustrating a method for configuring a frame according to an example embodiment of the present invention;

FIG. 19 is a block diagram illustrating a base station according to an example embodiment of the present invention;

FIG. 20 is a flow chart illustrating a method for a mobile terminal to acquire synchronization according to an example embodiment of the present invention; and

FIG. 21 is a block diagram illustrating a mobile terminal according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

A “cell” or a “base station” used in this disclosure generally refers to a fixed or mobile point that communicates with a terminal and may be a term for collectively referring to a base station, node-B, eNode-B, a BTS (base transceiver system), an access point, a transmit point, a receive point, an RRH (Remote Radio Head), an RRE (Remote Radio Element), an RRU (Remote Radio Unit), a relay, a femto-cell, etc.

Hereinafter, embodiments of the present invention will be described in detail with reference to the appended drawings. In the following description, for easy understanding, like numbers refer to like elements throughout the description of the figures, and the same elements will not be described further.

The present invention is based on a fact that, when frequency band much higher than frequency bands which conventional mobile communication system uses is used, more wide spacing between subcarriers should be used in consideration of physical effects such as frequency offsets and spreading due to Doppler effect, and a length of an OFDM symbol should be shortened accordingly.

As described above, it is essential to change frame structures and channel structures of a mobile communication system according to frequency bands and transmission schemes. The present invention is related to a frame structure which should be changed and considered essentially in a millimeter-wave communication, and is further related to a synchronization signal in such the frame structure.

In the following description, a frame structure, which is being used in the LTE mobile communication system, will be explained. Then, a frame structure and a structure of a synchronization signal for a millimeter-wave communication, according to the present invention, will be described.

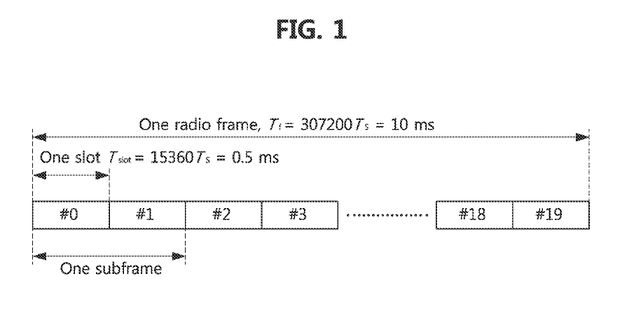

FIG. 1 is a view illustrating a frame structure and a channel structure of an LTE system which is a conventionally used mobile communication system.

FIG. 1 represents a first type structure of a frame in the LTE system, defined in a physical layer specification of the LTE. In addition to the frame structure depicted in FIG. 1, various types of frame structures are defined for the LTE system according to transmission schemes which are being used.

T_{f} is a time duration of 10 ms corresponding to a radio frame. Also, Tₛₗₒₜ is a time duration of 0.5 ms corresponding to a slot, and two slots constitutes a sub-frame. Accordingly, 10 sub-frames (or, 20 slots) constitute a radio frame. The minimum time unit constituting a radio frame is a time duration Tₛ corresponding to a sample, and 307,200 samples constitute 10 ms. In other words, T_{f}=307,200 Tₛ, and Tₛ becomes 1/30720 ms.

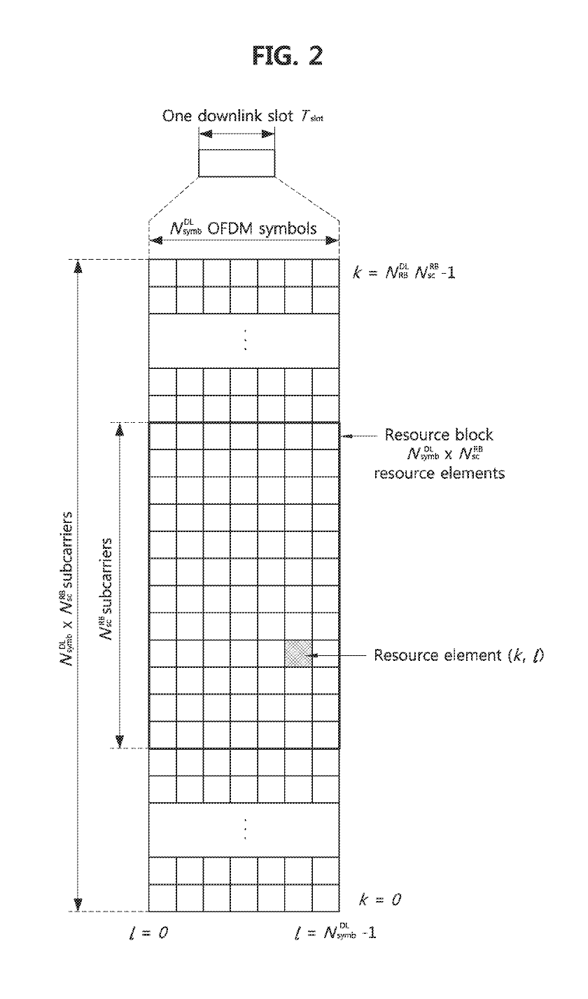

FIG. 2 is a view illustrating a structure of radio resources in the LTE system.

FIG. 2 also represents a frame structure of the LTE system, defined in the physical layer specification of the LTE, in further detail than FIG. 1.

The vertical axis of FIG. 2 represents a frequency domain, and the horizontal axis of FIG. 2 represents a time domain. A small rectangle is referred to as a Resource Element (RE) having a frequency width of 15 kHz and a time duration corresponding to a length of an OFDM symbol. A RE is used as a minimum unit of time and frequency resources used for allocating wireless data. Here, a RE is indicated in a manner of (k,l) by using a frequency domain index k and a time domain index l.

In the time domain, there are N_{symb}^{DL} OFDM symbols in a slot. The value of N_{symb}^{DL} may vary according to a Cyclic Prefix (CP). That is, it may be 7 for a normal CP case, and it may be 6 for an extended CP case.

A Resource Block (RB) as an unit of block may comprise N_{SC}^{RB} subcarriers in the frequency domain, and N_{symb}^{DL} OFDM symbols in the time domain. N_{SC}^{RB} may be 24 when an extended CP is used and a spacing between subcarriers is configured to 7.5 kHz. In other cases, N_{SC}^{RB} may be 12. A RB may comprise N_{SC}^{RB}×N_{symb}^{DL} REs. If a size of frequency band used in the LTE system is represented as the number of RBs, it may be N_{RB}^{DL}. In this case, the frequency band used in the LTE system has N_{RB}^{DL}×N_{SC}^{RB} subcarriers.

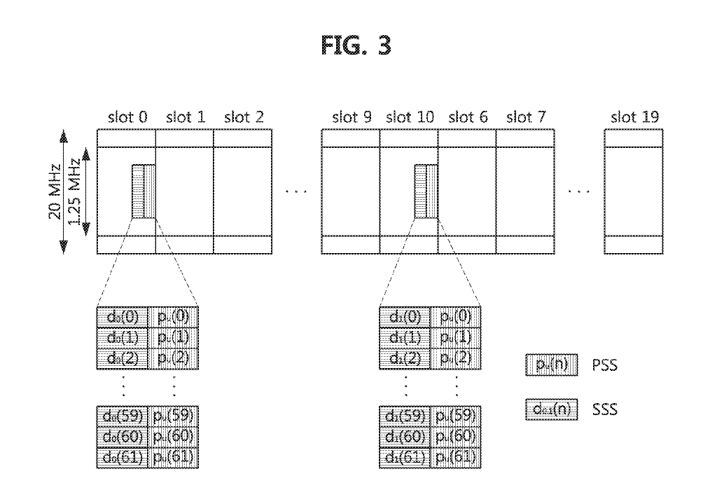

FIG. 3 is a view illustrating a structure of a synchronization signal in the LTE system.

In FIG. 3, a frequency domain represents a 20 MHz band, and a time domain represents 20 slots which are corresponding to 10 ms.

The synchronization signal for the LTE system may be classified into a Primary Synchronization Signal (PSS) and a Secondary Synchronization Signal (SSS), each of which occupies a time duration corresponding to 2 OFDM symbols in a radio frame. They occupy a frequency band smaller than 1.25 MHz which is the smallest frequency band for the LTE.

According to the above-described configuration of the synchronization signals, a terminal can receive the synchronization signal from any LTE base stations using the smallest frequency bandwidth or using the largest frequency bandwidth. Each of the PSS and the SSS comprises sequences with a length of 62, and the PSS repeats at periods of 5 ms, and the SSS repeats at periods of 10 ms.

Therefore, in FIG. 3, although a PSS of a slot 0 and a PSS of a slot 10 are identical, a SSS of the slot 0 is different from a SSS of the slot 10. In a case of such the configuration of the synchronization signals, a terminal which receives the synchronization signal may determine a 5 ms symbol position by using the PSS, and may determine a 10 ms frame position by using the SSS.

One of important functions of synchronization is detecting a cell identity (or, a cell ID). Two sequences depicted in FIG. 3 may be belonging to 504 sequences corresponding to 504 cell identities. Specifically, a cell identity may be represented as 3×N_{ID}⁽¹⁾+N_{ID}⁽²⁾, and N_{ID}⁽²⁾ may be one of 0, 1, and 2, and N_{ID}⁽¹⁾ may be one of 0˜167. Thus, it is possible to make 504 combinations by using N_{ID}⁽¹⁾ and N_{ID}⁽²⁾, and each of the combinations corresponds to a cell identity. A sequence corresponding to a PSS may be represented as below equation 1. If N_{ID}⁽²⁾ is 0, 1, or 2, u corresponding to N_{ID}⁽²⁾ may be 25, 29, or 34.

$${p}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix} \qquad [ Equation 1 ]$$

Also, a sequence corresponding to a PSS may be represented as below equation 2.

$$d ( 2 n ) = \{ \begin{matrix}{s}_{0}^{( {m}_{0} )} {c}_{0} ( n ) in slot 0 \\ {s}_{1}^{( {m}_{1} )} {c}_{0} ( n ) in slot 10\end{matrix} \\ d ( 2 n + 1 ) = \{ \begin{matrix}{s}_{1}^{( {m}_{1} )} {c}_{1} ( n ) {z}_{1}^{( {m}_{0} )} ( n ) in slot 0 \\ {s}_{0}^{( {m}_{0} )} {c}_{1} ( n ) {z}_{1}^{( {m}_{1} )} ( n ) in slot 10\end{matrix} \qquad [ Equation 2 ]$$

S₀^{m}^{₀} and S₁^{m}^{₁} which correspond to basic sequences, may be m-sequences generated using a polynomial x⁵+x²+1 and an initial condition, x(0)=0,x(1)=0,x(2)=0, x(3)=0,x(4)=1, and cyclic-shifted respectively by m₀ and m₁. The remarkable point in the equation 2 is that the slot 0 and the slot 10 may use the identical basic sequences S₀^{m}^{₀} and S₁^{m}^{₁}, but the opposite sequences are used for an odd-numbered slot and an even-numbered slot.

Although the identical sequences are used, the slot 0 and the slot 10 may have different SSSs by changing arrangement order of the sequence in an odd-numbered slot and an even-numbered slot. By doing this, a 10 ms frame position may be determined by detecting only one symbol. However, since a performance may degrade if only basic sequences are used, it should be noted that scrambling sequences c₀(n), c₁(n), z₁^{(m}^{₀}⁾(n), z₁^{(m}^{₁}⁾(n) are used additionally.

The present invention is related to a case in which millimeter-wave frequency is used as a carrier frequency. The millimeter-wave may mean an electromagnetic wave corresponding to a carrier frequency from 30 to 300 GHz (that is, an electromagnetic wave having a wave length ranged from 1 to 10 mm). Since the millimeter wave is in the middle of a frequency band used for wireless communication and an infrared band (0.1 mm), it has properties close to those of a light (for example, a feature of straight), and it also can be referred to as an Extremely High Frequency (EHF). Since the millimeter wave band may have a much wider frequency bandwidth as compared to a carrier frequency band used for cellular communication, it has advantages in transmission of relatively large amount of data. However, there may be shortcomings of a higher path loss when it is emitted to a space.

When a millimeter wave band is used as a carrier, there may be characteristics different from conventional cellular communication frequency bands (such as those of a GSM, a WCDMA, a LTE, etc.). The Doppler effect, in which a frequency experienced by a moving object changes proportionally to a velocity of the moving object, may be an example. A frequency change experienced by an object moving with a velocity of v may be represented as below equation 3. Here, Δf may mean a frequency change experience by the moving object, and f₀ may mean an original frequency.

$$Δ f = \frac{v}{c} {f}_{o} \qquad [ Equation 3 ]$$

The above described frequency shift may be proportional to a moving velocity of the object, and also be proportional to an original carrier frequency (f₀). Therefore, Doppler shift may be bigger in the millimeter-wave band as the millimeter-wave has a higher frequency. Therefore, when the millimeter-wave is used for a cellular communication using OFDM transmission scheme, a sub-carrier spacing should be larger so that it may not be affected by a frequency offset caused by the Doppler shift. Thus, a length of an OFDM symbol is shortened, and a frame structure for the millimeter-wave should be changed.

In other words, a frame structure used for conventional cellular communication bands cannot be used for a millimeter-wave band. Accordingly, a new frame structure suitable for the millimeter-wave should be designed, and a structure of synchronization signal suitable for the new frame structure is also required to be designed. In the following descriptions, in a case in which an OFDM transmission scheme is used for a cellular communication using a millimeter-wave band, a suitable frame structure and a synchronization signal structure suitable for the frame structure will be proposed.

Frame Structure

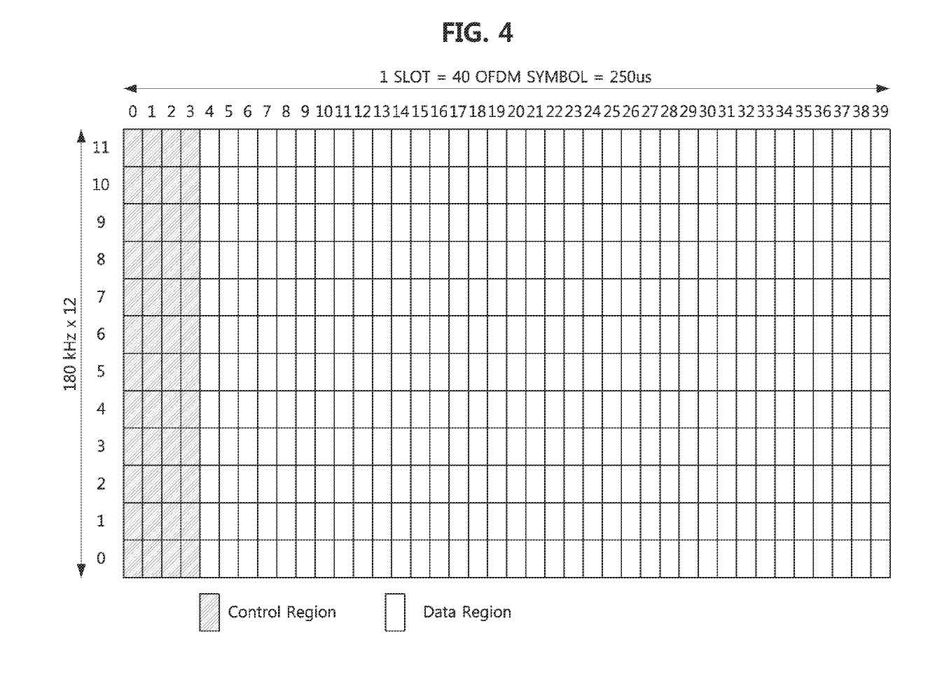

FIG. 4 is a view illustrating an example embodiment of a frame structure used in a cellular communication system using an OFDM manner using millimeter-waves.

A small rectangle may mean a resource element (RE). However, as compared to an example of the LTE (as shown in FIG. 2), a resource occupied by a RE may be 180 kHz×5.56 μs. That is, spacing between sub-carriers may be 180 kHz in frequency domain, and a spacing in time domain may be 5.56 μs. As compared to the conventional LTE, spacing between subcarriers is enlarged by twelve times, and spacing between OFDM symbols is shortened as one-twelfth. It is usual that spacing between subcarriers is determined in consideration of Doppler shift generated in a carrier frequency.

If a carrier frequency is near 30 GHz, approximately, Doppler shift of 11 kHz may be generated for an object moving with a velocity of 400 km/h, and it is corresponding to 6% of the spacing between subcarriers. If a carrier frequency is near 30 GHz, Doppler shift may also increases approximately to 110 kHz, and it is preferable to enlarge the subcarrier spacing to 1.8 MHz. However, in this case, a length of an OFDM symbol may be shortened to 0.556 μs, a significantly short length.

Therefore, FIG. 4 supposes a case in which a carrier frequency, among millimeter-waves, is near 30 GHz or under 30 GHz. For reference, since an operating frequency band of the conventional LTE system ranges only from 900 MHz to 3 GHz, a spacing between subcarriers, 15 kHz may be applied to all frequency bands without any problem. In FIG. 4 illustrating a frame structure according to an example embodiment of the present invention, a Resource Block (RB) is defined to comprise 12 subcarriers in frequency domain, and 40 OFDM symbols in time domain.

The RB is an unit of block for defining mobile communication radio resources, and a RB occupies a frequency band of 2.16 MHz (180 kHz×12) and a time duration of 250 μs. Especially, since each OFDM symbol requires a Cyclic Prefix (CP) whose length corresponds to one-eighth of the OFDM symbol length, the length of 40 OFDM symbols becomes 250 is (not 40×5.56=222.4 μs). In a RB, a former part which is depicted as filled with deviant crease lines may represent a control channel region, and the rest part may represent a data channel region. The control channel region may occupy 10% of the total RB. However, the occupation ratio of the control channel region may be varied. That is, when the more control channels are required to be transmitted, the more resources can be allocated to the control channel region. On the contrary, the resources for the control channel region may be reduced.

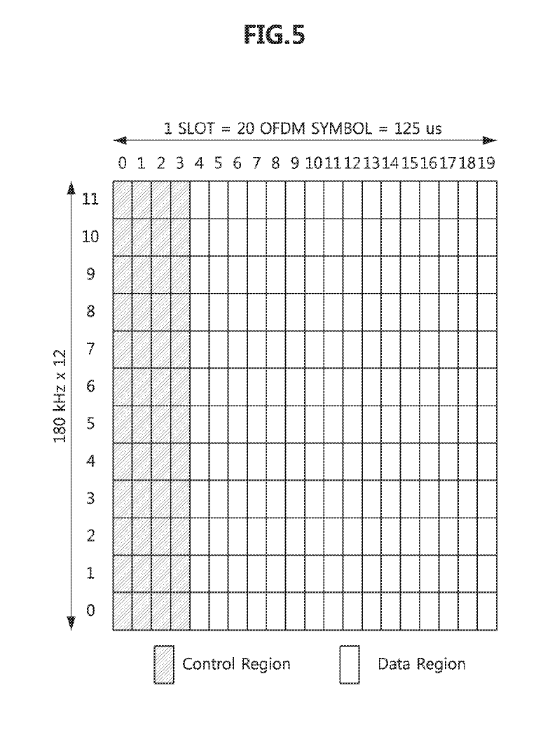

FIG. 5 is a view illustrating a frame structure according to another example embodiment of the present invention, in an OFDM mobile communication system using millimeter-waves.

In FIG. 5, similarly to the case of FIG. 4, spacing between subcarriers is supposed to be 180 kHz and a length of an OFDM symbol is supposed to be 5.56 μs. However, differently from the case of FIG. 4, in an example embodiment of FIG. 5, a RB comprises 12 subcarriers in frequency domain and 20 OFDM symbols in time domain.

Although a RB in FIG. 4 occupies 250 μs in time domain, a RB in FIG. 5 may occupy 125 μs. Since resources occupied by a RB are configured differently, the number of REs included in a RB (a basic unit of frequency-time resource allocation) may be different. Here, a size of resources owned by a RB may become different according to a type of service. Since the minimum unit for resource allocation is usually a RB, a size of RB may be determined according to a service requiring small amount of resources.

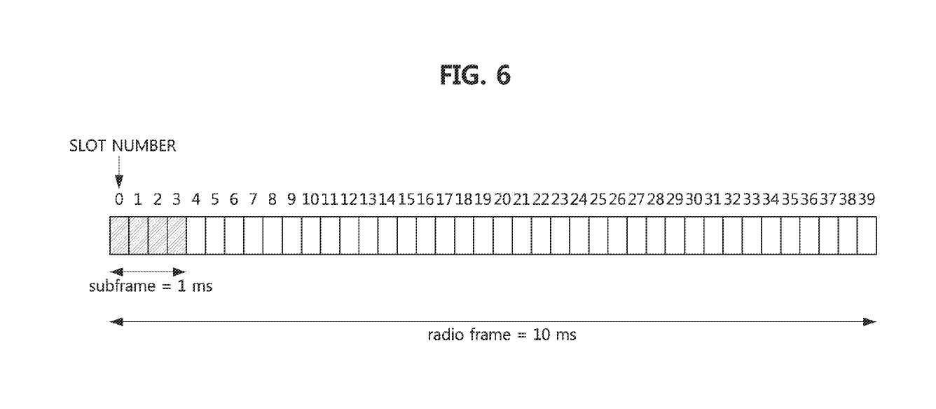

FIG. 6 is a view illustrating a frame structure according to another example embodiment of the present invention, in an OFDM mobile communication system using millimeter-waves.

An example, in which a 1 ms subframe and a 10 ms radio frame are configured using RBs depicted in FIG. 4, is illustrated in FIG. 6. Since the slot number is assigned to each slot corresponding to a length of a RB, 250 μs, four slots are included within 1 ms, and forty slots are included within 10 ms. If a 1 ms subframe and a 10 ms radio frame are configured according to the structure depicted in FIG. 5, they comprises eight slots and eighty slots respectively.

Synchronization Signal Structure

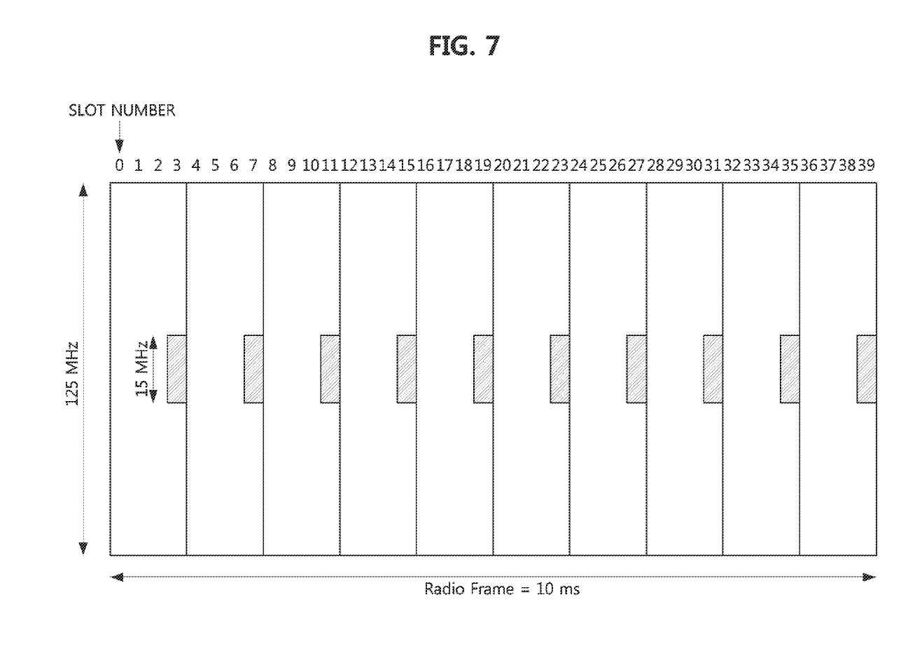

FIG. 7 is a view illustrating a synchronization signal in a radio frame according to an example embodiment of the present invention.

When a slot is supposed to have 250 μs duration, that is, the frame structure depicted in the example embodiment of FIG. 4 is supposed to be used, synchronization signals are located at periods of 1 ms which corresponds to four slots. Thus, synchronization signals are located ten times in a 10 ms radio frame.

Although a synchronization signal is located in the last slot of the four slots within 1 ms in the case depicted in FIG. 7, the synchronization signal may be located in other slot. However, a structure of each 1 ms should be maintained during 10 ms. The slot number of a slot to which synchronization signals are allocated is represented as 4n+k, k=0 or 1 or 2 or 3, n=0, 1, . . . 9. In frequency domain, synchronization signals may be located in only some bands located in center of overall bands. For example, when total frequency bandwidth is 125 MHz, a total bandwidth in which the synchronization signal is located may be 15 MHz.

For reference, a 125 MHz bandwidth may hold 600 subcarriers with spacing of 180 kHz, and a 15 MHz bandwidth may hold 72 subcarriers. Since a frequency bandwidth which 600 subcarriers occupy is 108 MHz, 17 MHz of 125 MHz becomes a guard band.

Since 72 subcarriers near a center frequency occupy 12.96 MHz, 2.04 MHz of 15 MHz becomes a guard band. Thus, when a frequency bandwidth is equal to or above 15 MHz, and equal to or below 125 MHz, a structure of synchronization signal depicted in FIG. 7 may be used. If a frequency bandwidth is over 125 MHz, a carrier aggregation technique may be additionally used in unit of 125 MHz.

As an alternative solution, the method of configuring one of 250 MHz, 500 MHz, and 1 GHz, not 125 MHz, for a total bandwidth is possible. For each case, a frequency band which synchronization signals occupy may be configured as the smallest frequency band which can be supported as shown in FIG. 7.

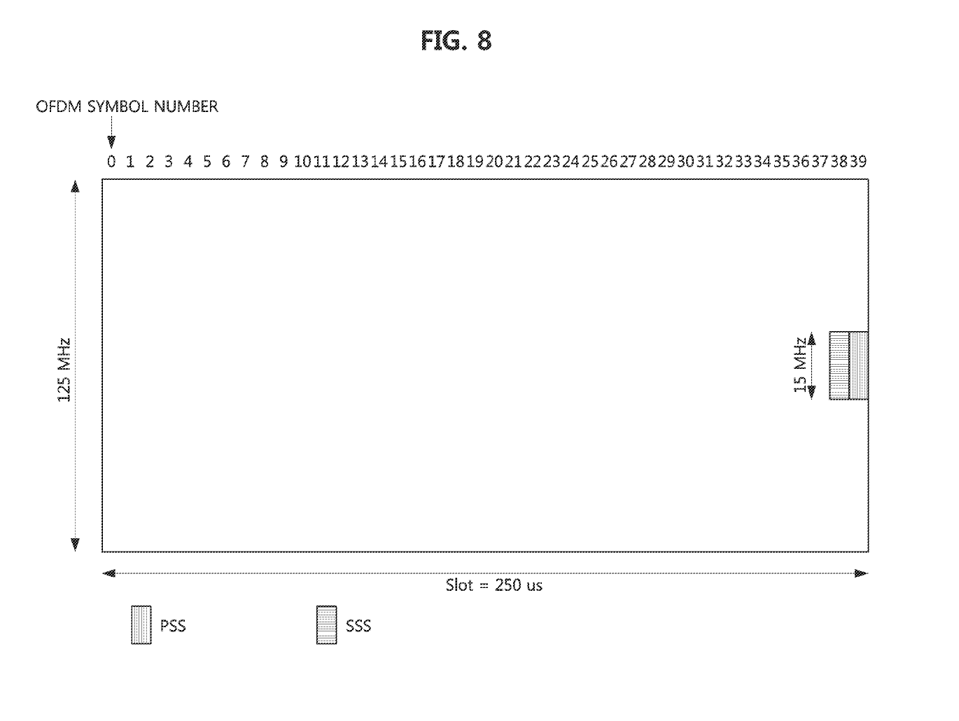

FIG. 8 is a view illustrating a detail structure of a synchronization signal according to an example embodiment of the present invention.

That is, FIG. 8 represents an expanded view of a slot corresponding to a region filled with deviant crease lines in FIG. 7.

That is, a length of time depicted in FIG. 8 is 250 μs which corresponds to a length of a slot. FIG. 8 shows an expanded view of a slot corresponding to a region filled with deviant crease lines in FIG. 7. Index numbers from 0 to 39, which are noted above the frame structure, may represent a symbol number of OFDM symbols.

The vertical axis, the frequency domain may be identical to the case of FIG. 7. According to an example embodiment of synchronization signal structure of the present invention, a primary synchronization signal is located in the last symbol of 40 OFDM symbols, and a secondary synchronization signal is located in the previous symbol of the last symbol. Of course, a primary synchronization signal or a secondary synchronization signal may be located in other OFDM symbols. However, in consideration of its usage for finding a temporal boundary point, it is preferable that synchronization signals are located in a first or a last OFDM symbol. Since a region for control channel is usually located in a starting symbol, it is natural to locate the synchronization signal in OFDM symbols of an ending part of the slot.

The primary synchronization signal has a structure of repeating every 1 ms. That is, the primary synchronization signal repeats 10 times in a 10 ms radio frame. Therefore, if a primary synchronization signal is received and detected, a boundary of a 1 ms frame can be detected. However, since 10 1 ms frames exist in a 10 ms frame, it cannot be identified which 1 ms frame the detected boundary is belonging to. It can be identified where the detected 1 ms frame is located in a 10 ms frame by using a secondary synchronization signal.

According to structures of synchronization signals depicted in FIG. 7 and FIG. 8, the energy used for the synchronization signals corresponds to 0.15% of total energies. For example, this may be calculated by a ratio of the number of REs (72×2) used for synchronization signals the total number of REs within 1 ms (600×40×4).

Other example embodiments according to the present invention, which maintains the ratio of energy identical to that of example embodiments of FIG. 7 and FIG. 8, will be explained in the following descriptions by referring to figures.

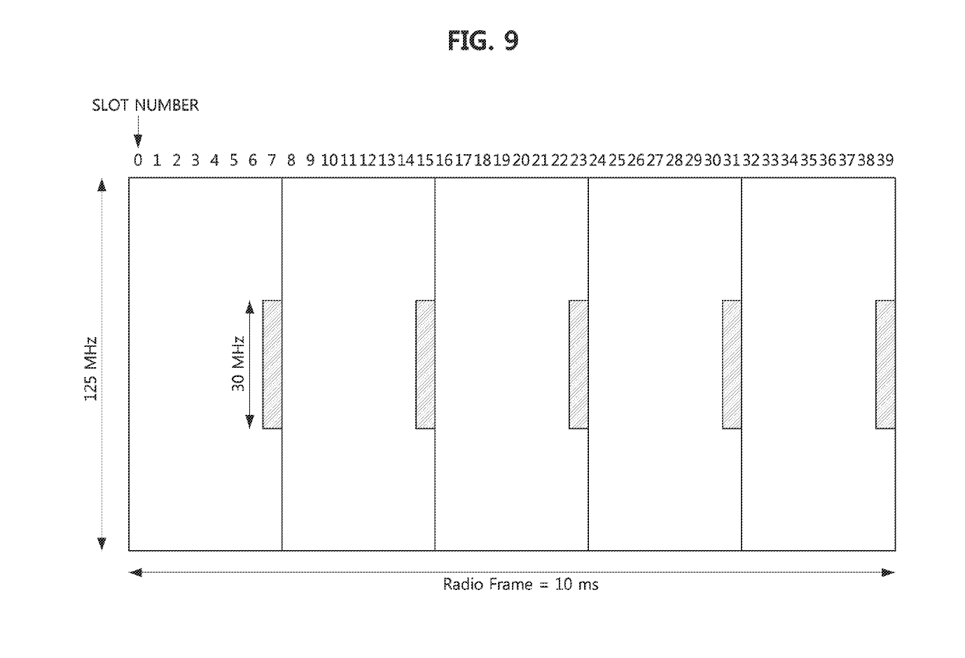

FIG. 9 is a view illustrating a structure of synchronization signal in a radio frame according to another example embodiment of the present invention.

The synchronization signal depicted in the example embodiment of FIG. 9 occupies 30 MHz bandwidth larger than 15 MHz of the example embodiment shown in FIG. 7 and FIG. 8. Also, the synchronization signals are transmitted at periods of 2 ms not 1 ms.

Also, although the synchronization signal is located in a last slot of eight slots within 2 ms in the example embodiment of FIG. 9, the synchronization signal may be located in other slots. However, a structure of each 2 ms should be maintained during a radio frame of 10 ms.

The slot number of slots in which synchronization signals are located is represented as 8n+k, k=0 or 1 or 2 or 3 or 4 or 5 or 6 or 7, n=0, 1, . . . , 4.

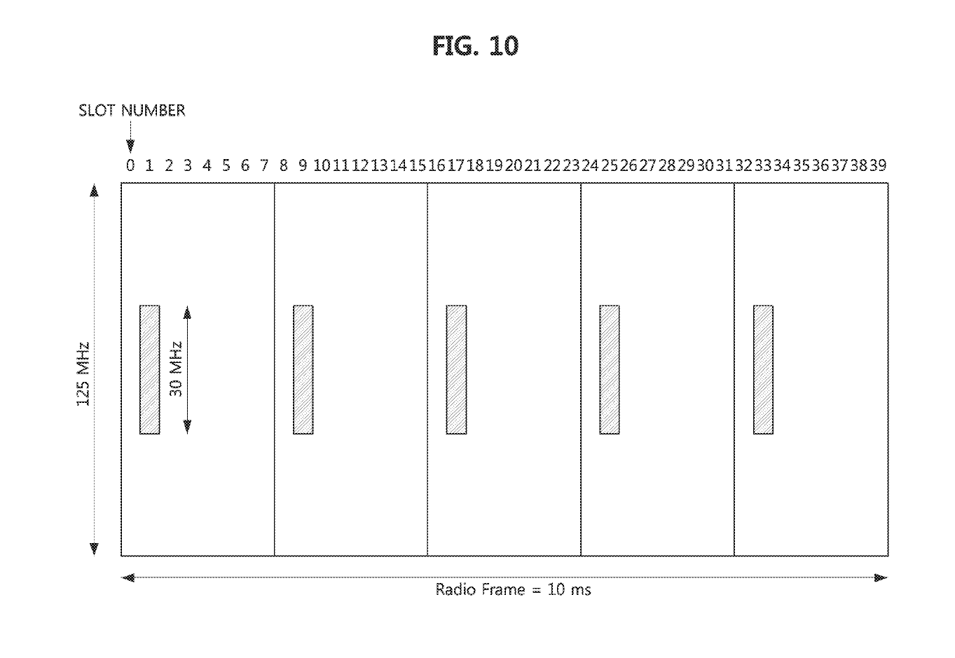

FIG. 10 is a view illustrating a structure of synchronization signal in a radio frame according to another example embodiment of the present invention.

As opposed to the above described example embodiments, an example, in which a synchronization signal is located in a second slot of eight slots within 2 ms, is illustrated in FIG. 10.

Such the structure is suitable for a Time-Domain Duplexing (TDD) manner in which the same frequency band is used for an uplink and a downlink and the uplink and the downlink are separated temporally.

According to the above described example embodiments, a boundary of 2 ms frame can be detected by using a primary synchronization signal, and a boundary of 10 ms frame can be detected by using a secondary synchronization signal. However, as described above, when the frequency bandwidth occupied by the synchronization signals is doubled, the total bandwidth provided by the system should be at least 30 MHz in order to provide services.

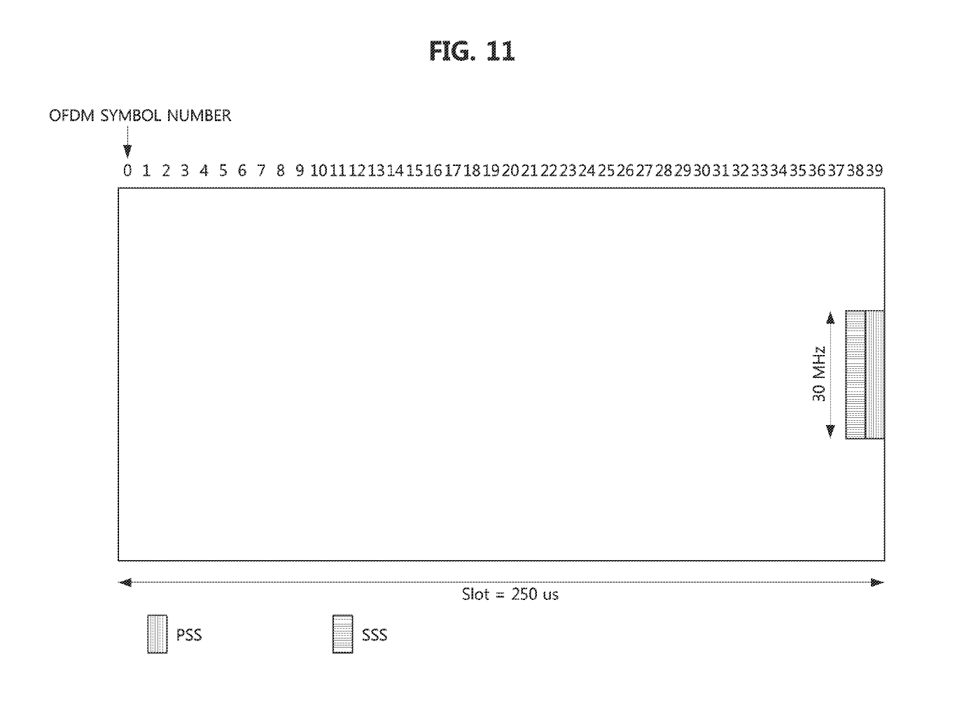

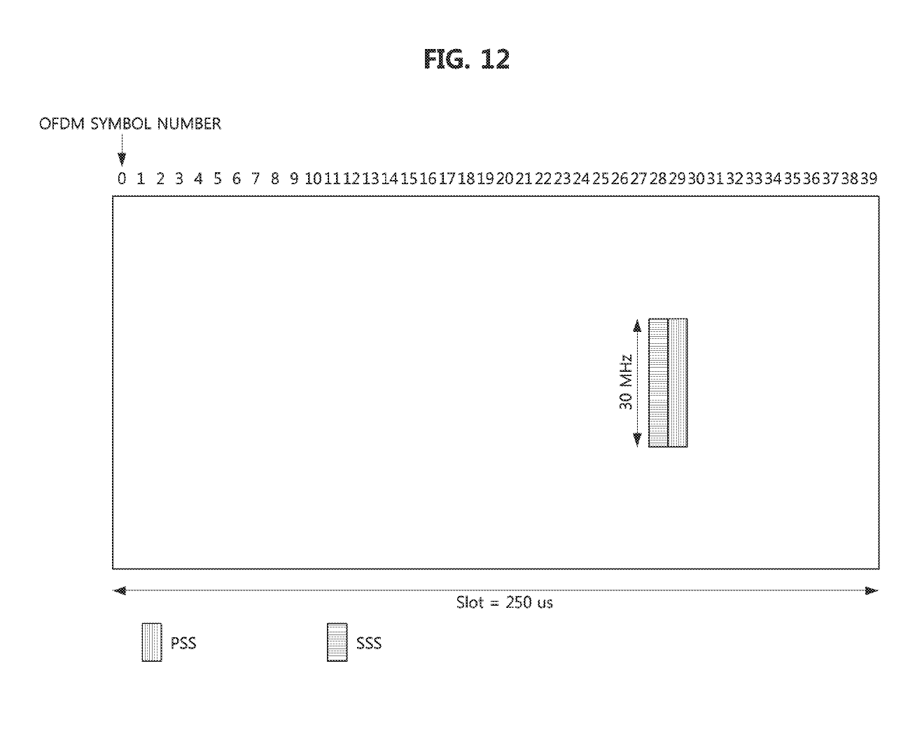

FIG. 11 and FIG. 12 are views illustrating detail structures of synchronization signals according to another example embodiment of the present invention.

FIG. 11 shows the structure of the synchronization signal depicted in FIG. 9 in further detail.

FIG. 11 shows an example embodiment in which synchronization signals are located in the last two symbols among 40 OFDM symbols included in a slot.

Meanwhile, FIG. 12 shows the structure of the synchronization signal depicted in FIG. 10 in further detail.

That is, FIG. 12 shows an example embodiment in which synchronization signals are located in the 29^{th} symbol and the 30^{th} symbol among 40 OFDM symbols included in a slot.

As shown in FIG. 11 and FIG. 12, synchronization signals according to the present invention may be located in any OFDM symbols within a slot. However, several points should be considered as follows.

First, since control channels occupy OFDM symbols in a former part of a frame, it is preferred that they are located without being overlapped with the control channels.

Second, since they are downlink synchronization signals, they should be located in OFDM symbols for downlink.

In an example embodiment of FIG. 12 which explains the case of TDD frame, OFDM symbols from 0 to 29 are for the downlink, and OFDM symbols from 30 to 39 are for a guard period and the uplink.

Third, they are located adjacent to OFDM symbols for a Broadcast Channel (BCH), which is a broadcasting channel, so that channel estimation using the synchronization signals can be used for demodulation and decoding of the BCH.

Fourth, a primary synchronization signal and a secondary synchronization signal should be located as adjacent or near to each other, so that frequency offset correction and channel compensation for the secondary synchronization signal, by using the primary synchronization signal, may be made easier.

In the present invention, OFDM symbols for synchronization signals are located within a slot in consideration of the above described points.

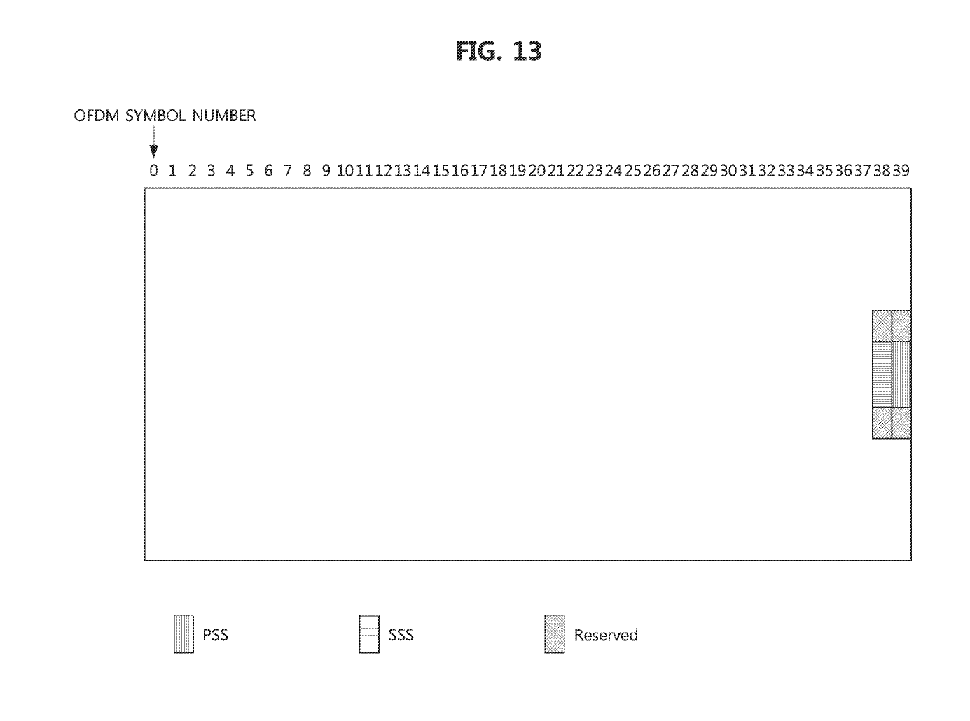

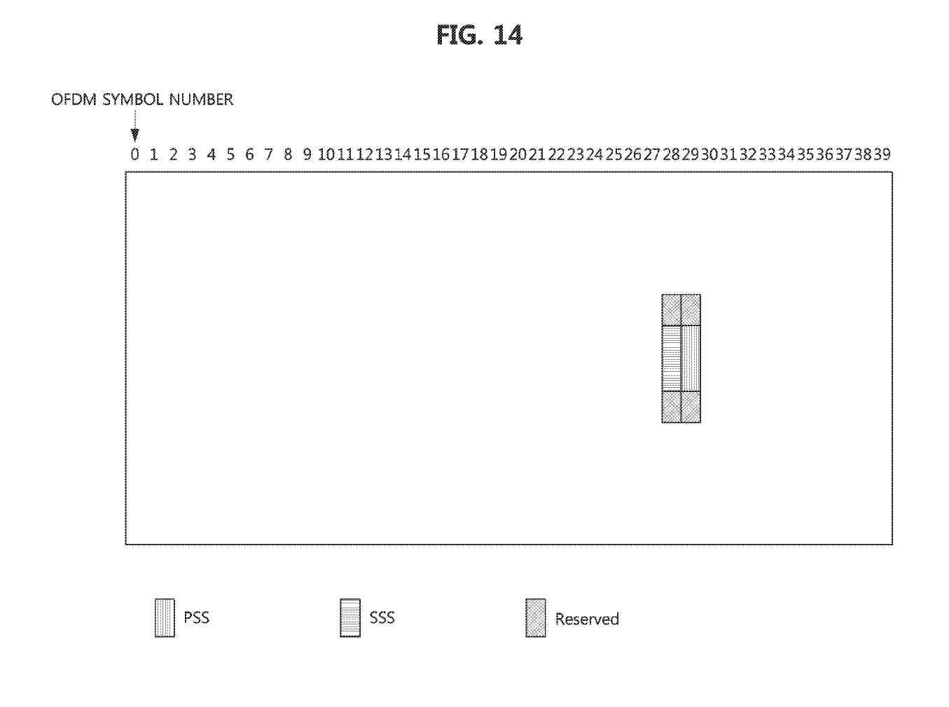

FIG. 13 and FIG. 14 are views illustrating detail structures of synchronization signals according to another example embodiment of the present invention.

A case of FIG. 13 has arrangement of OFDM symbols identical to the case of FIG. 11, and a case of FIG. 14 has a structure of synchronization signals located in OFDM symbols identically to the case of FIG. 12.

Frequency bandwidth occupied by a primary synchronization signal and a secondary synchronization signal is identical to both the example embodiment shown in FIG. 13 and FIG. 14 and the example embodiment shown in FIG. 11 and FIG. 12. However, in FIG. 13 and FIG. 14, sequences are allocated to only half of frequency bandwidth located in a center of the whole synchronization signal frequency bandwidth, and sequences are not allocated to the rest half of the whole synchronization signal frequency bandwidth.

While signal is not transmitted in the non-central region, the half of the whole synchronization signal bandwidth, sequences which are allocated in the center may be transmitted with a doubled power, so that total transmission power may be identical to the case in which synchronization signals are transmitted using the whole synchronization signal frequency bandwidth. Accordingly, since the length of sequences may become half as compared to the example embodiment of FIG. 11 and FIG. 12, maintaining transmission power identical to the example embodiment of FIG. 11 and FIG. 12, complexity of a synchronization signal receiving part may be reduced.

In the above descriptions, structures of synchronization signals according to the present invention were explained. Hereinafter, sequences of synchronization signals according to the present invention will be explained.

Synchronization Signal Sequence

In the present invention, various synchronization signal sequences, suitable for the above-described example embodiments of synchronization signals, are proposed.

First, a sequence corresponding to an example embodiment of a synchronization signal according to the present invention, shown in FIG. 7 and FIG. 8, is explained.

The length of the primary synchronization signal is 62, and Zadoff-Chu sequence which is used in the LTE system may be used for the primary synchronization signal as described below. However, it is not necessary that u is selected identically to that of the LTE case. That is, u can be three discriminable values selected among values from 0 to 62. These values correspond to N_{ID}⁽²⁾=0, 1, 2, which are first cell information for discriminating cells, similarly to the LTE system. The reason why equations for n=0, . . . , 30 and n=31, . . . , 61 are different is that a sequence is not allocated to a center subcarrier (a DC component) located in a center of frequency band used by a system.

$${p}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix} \qquad [ Equation 4 ]$$

A terminal may identify u by detecting the primary synchronization signal in a first stage for acquiring synchronization with a base station, and detect a boundary of 1 ms frame.

A second stage for acquiring synchronization with a base station is performed by using a secondary synchronization signal, and a sequence for the secondary synchronization signal according to an example embodiment of the present invention may be defined as below equation 5.

d(n)=s^{m}^{ᵢ}(n) in Slot 4i+3 and i=0, 1, . . . , 9

s^{(m}^{ᵢ}⁾=\tilde{s}((n+mᵢ)mod 62)

\tilde{s}=1−2x(i), 0≦i≦61 [Equation 5]

Here, d(n) is a sequence for a secondary synchronization signal.

Also, x(i) is a m-sequence generated using a polynomial x⁶+x+1 and an initial condition x(0)=0,x(1)=0,x(2)=0,x(3)=0,x(4)=0,x(5)=1.

A sequence \tilde{s} is a sequence converted to −1 or 1 from x(i), and is cyclic-shifted by mᵢ, so that it becomes s^{(m}^{ᵢ}⁾. Also, mᵢ is a hopping code according to the present invention, and is a hopping code satisfying a hamming distance of 8 in this example.

The meaning of ‘cyclic-shift’ is explained as follows. For example, if a sequence “0, 1, 2, . . . , 61” is cyclic-shifted by 1, then the cyclic-shifted sequence may be “1, 2, . . . , 61, 0”. Also, if it is cyclic-shifted by 2, then the cyclic-shifted one may be “2, 3, 4, . . . , 61, 0, 1”. In the LTE system, a sequence having a length of 31 is cyclic shifted by different values m₀ and m₁, and two cyclic-shifted sequences are located in turn at odd-numbered REs and at even-numbered REs so that a sequence having a length of 62 is made.

However, in the present invention, a length of a sequence is 62 so that a m-sequence may be used. In this case, a degree of a polynomial for generating the secondary synchronization signal according to the present invention may be 6. The method for generating the sequence using such the polynomial may be represented as below equation 6.

x(i+6)=(x(i+1)+x(i))mod 2, 0≦i≦55 [Equation 6]

In the above equation 6, a result of an operation (mod 2) means a remainder of division by 2.

Meanwhile, mᵢ in the above equation 5 was explained as a hopping code according to the present invention. The hopping code according to the present invention is a cell-specific value, and may be defined as 10 values {m₀, m₁, . . . , m₉} each of which corresponds to one of second cell information N_{ID}⁽¹⁾=0, 1, . . . , 167 for discriminating cells in one-to-one manner. Cyclic shifting corresponding to mᵢ is performed in each of 10 slots, and 10 different sequences are used in a single radio frame within 10 ms.

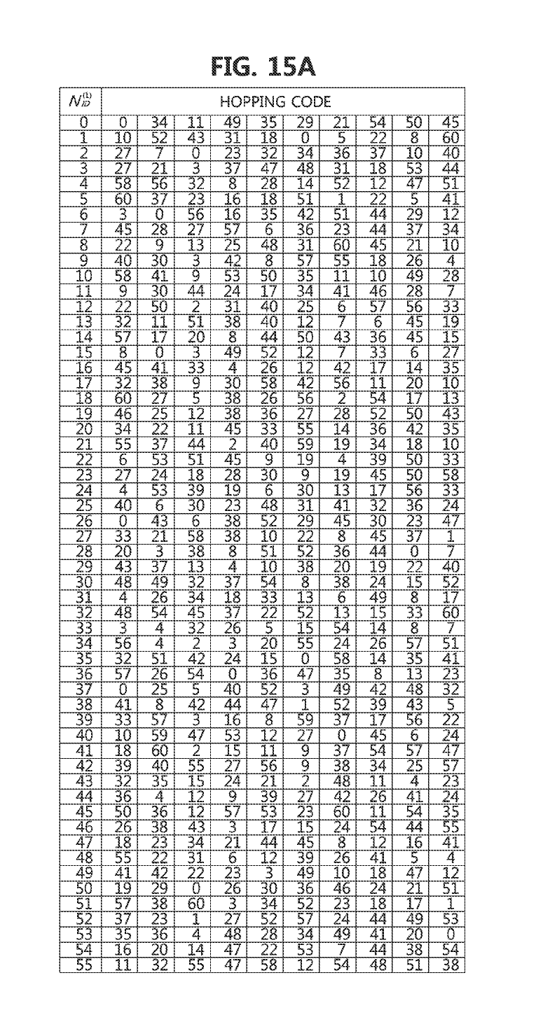

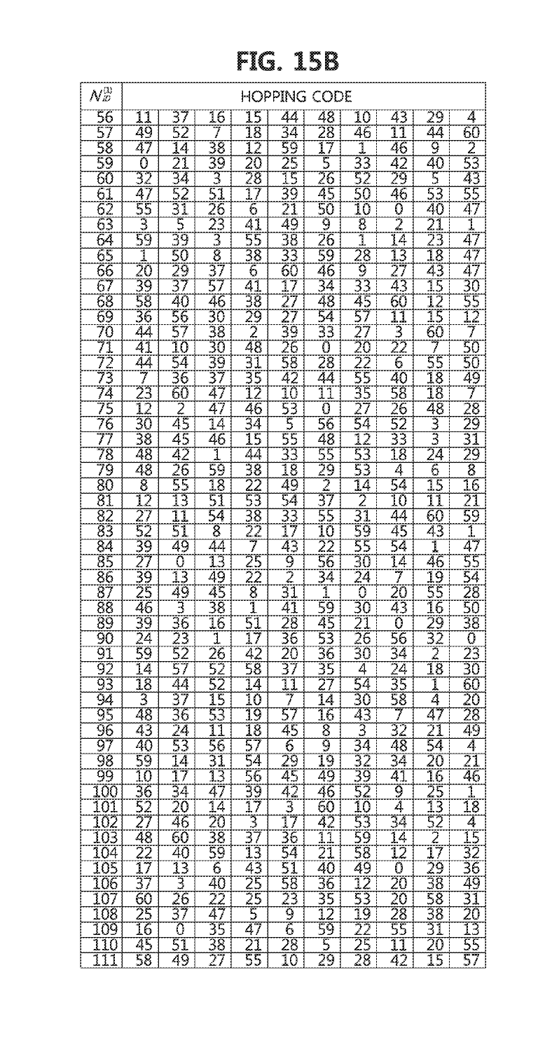

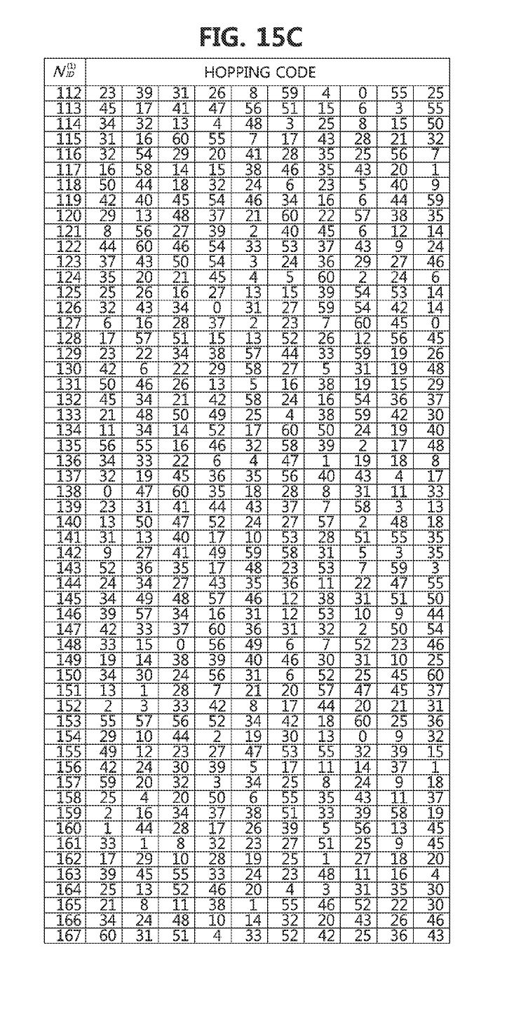

Values represented in FIGS. 15A to 15C are computer-generated random numbers for a case that Alphabet size is 62 and a length of hopping code is 10. The number of sets of such the random numbers is larger than 168, and values represented in FIGS. 15A to 15C are values selected among the sets. However, when a hamming distance is above 9, 168 sets cannot be made. The meaning of a hamming distance of 8 is that at least 8 different values exist between hopping codes corresponding to arbitrary two second cell information N_{ID}⁽¹⁾.

In other words, it may mean that the maximum number of values coinciding to each other between different hopping codes is 2. In this case, cyclic shifts are also considered for comparing two hopping codes. A terminal may determine a boundary of 1 ms by using the primary synchronization signal, and determined a boundary of 10 ms by using the secondary synchronization signal.

Specifically, in the structures depicted in FIG. 7 and FIG. 8, when a hamming distance between hopping codes is 8, at least three sequences are required to be compared in order to determine a boundary of 10 ms.

For example, in the case of the hopping code corresponding to second cell information N_{ID}⁽¹⁾=0 and the hopping code corresponding to N_{ID}⁽¹⁾=1, two hopping codes have the same m₀ and m₁. Thus, a hopping code can be discriminated by detecting up to m₂.

That is, if 3 sequences of 10 sequences constituting a hopping code are detected, the hopping code included in the secondary synchronization signal transmitted from a base station can be identified without comparing the rest of the sequences. If a terminal identifies a hopping code applied to the secondary synchronization signal, it can obtain second cell information, and obtain a cell identifier by combining the second cell information and the first cell information included in the primary synchronization signal. At this time, an effect of performance enhancement may be achieved when more than 4 sequences are accumulated. That is, when signal to noise ratio is low due to a poor radio environment, receiving performance may be increased by accumulating more sequences. Such the technique may be applied identically to example embodiments which will be explained in the following descriptions.

It is supposed that the hopping codes and the hamming distance between the hopping codes are defined as a specification between a base station and a terminal. That is, it is supposed that a terminal and a base station shares knowledge of them in advance.

A terminal may identify a cell identify corresponding to sets of u and mᵢ at the same time when the terminal detects a boundary of a 10 ms frame by using the primary synchronization signal and the secondary synchronization signal which are acquired through the above-described procedures. In other words, a cell identity (a cell ID) 3×N_{ID}⁽¹⁾+N_{ID}⁽²⁾ can be derived by using the first cell information and the second cell information obtained through the primary and secondary synchronization signals.

Hereinafter, a sequence of synchronization signals according to another example embodiment of the present invention will be explained.

In this example, a slot structure may adopt the structure depicted in FIG. 9 and FIG. 10, and a structure of OFDM symbols may adopt the structure depicted in FIG. 11 and FIG. 12. A sequence corresponding to synchronization signals depicted in FIG. 11 and FIG. 12 will be explained.

First, the length of the primary synchronization signal is 62, and Zadoff-Chu sequence may be used for the primary synchronization signal as described below. u can be three discriminable values selected among values from 0 to 125, each of which corresponds to N_{ID}⁽²⁾=0, 1, 2. The reason why equations for n=0, . . . , 62 and n=63, . . . , 125 are different is that a sequence is not allocated to a center subcarrier (a DC component) located in a center of frequency band used by a system.

$${p}_{u} ( n ) = \{ \begin{matrix}{e}^{- j \frac{π un ( n + 1 )}{127}} & n = 0 , 1 , … , 62 \\ {e}^{- j \frac{π u ( n + 1 ) ( n + 2 )}{127}} & n = 63 , 64 , … , 125\end{matrix} \qquad [ Equation 7 ]$$

A terminal may identify u by detecting the primary synchronization signal in a first stage for acquiring synchronization with a base station, and detect a boundary of 2 ms frame. A second stage is performed by using a secondary synchronization signal, and a sequence for the secondary synchronization signal may be defined as below equation 8.

d(n)=s^{m}(n) in Slot 8i+7 (or 1) and i=0, 1, . . . , 4

s^{(m}^{ᵢ}⁾=\tilde{s}((n+mᵢ)mod 126)

\tilde{s}=1−2x(i), 0≦i≦125 [Equation 8]

x(i) is a m-sequence generated using a polynomial x⁷+x+1 and an initial condition x(0)=0,x(1)=0,x(2)=0,x(3)=0,x(4)=0,x(5)=0,x(6)=1.

A sequence \tilde{s} is a sequence converted to −1 or 1 from x(i), and is cyclic-shifted by mᵢ, so that it becomess^{(m}^{ᵢ}⁾. Also, mᵢ is a hopping code according to the present invention, and is a hopping code satisfying a hamming distance of 4 in this example.

Since the length of the m-sequence is 126, a degree of the polynomial for generating the m-sequence may be 7.

The method for generating the sequence using such the polynomial may be represented as below equation 9.

x(i+7)=(x(i+1)+x(i))mod 2, 0≦i≧118[Equation 9]

As explained in FIG. 8, mᵢ is a hopping code, and may be defined as 5 values {m₀, m₁, . . . , m₄} each of which corresponds to one of first cell information N_{ID}⁽¹⁾=0, 1, . . . , 167, a cell-specific value, in one-to-one manner.

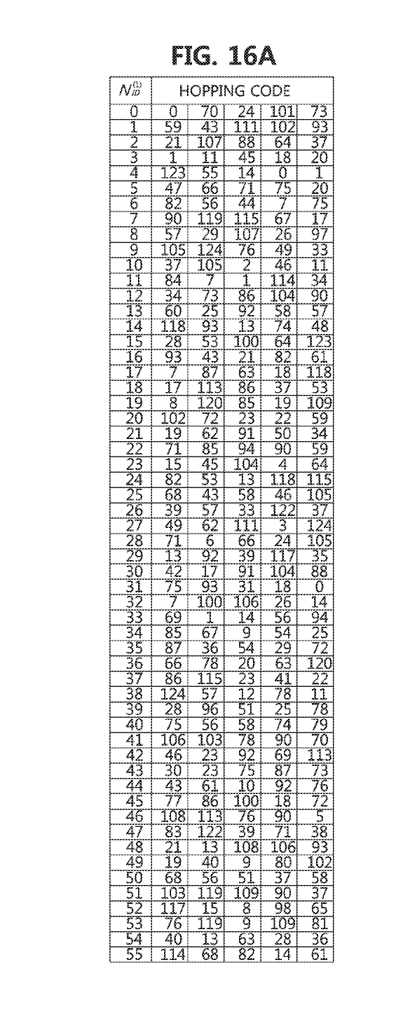

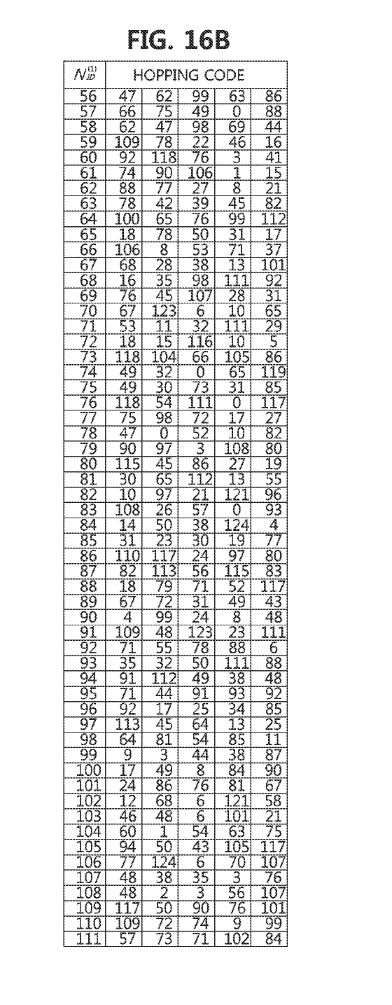

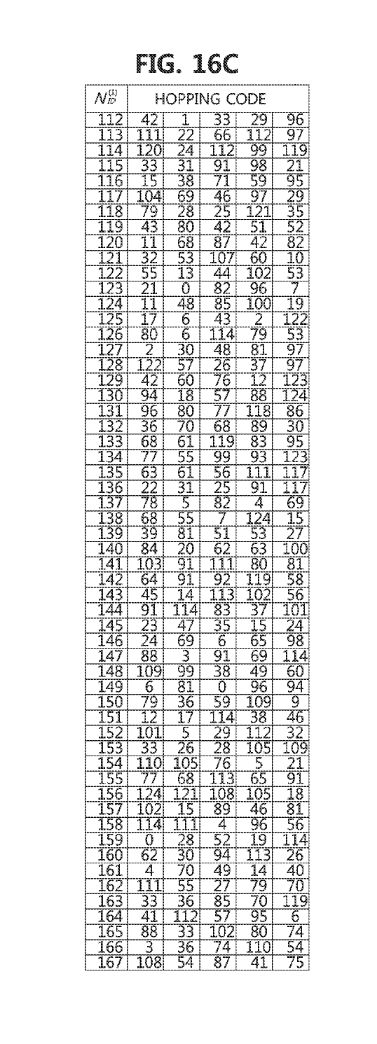

FIGS. 16A to 16C are views illustrating example embodiments of hopping codes satisfying a hamming distance of 4.

Values represented in FIGS. 16A to 16C are computer-generated random numbers for a case that Alphabet size is 126 and a length of hopping code is 5. The number of sets of such the random numbers is larger than 168, and values represented in FIGS. 16A to 16C are values selected among the sets.

The meaning of a hamming distance of 4 is that at least 4 different values exist between hopping codes corresponding to arbitrary two cell IDs. In other words, it may mean that the maximum number of values coinciding to each other between different hopping codes is 1. In this case, cyclic shifts are also considered for comparing two hopping codes.

A terminal may determine a boundary of 2 ms by using the primary synchronization signal, and determined a boundary of 10 ms by using the secondary synchronization signal.

Similarly to the structure of synchronization signal depicted in FIG. 9 and FIG. 10, when a hamming distance between hopping codes is 4, at least two sequences are required to be compared in order to determine a boundary of 10 ms. A cell identity corresponding to u and mᵢ may be identified at the same time when a boundary of a 10 ms frame is detected by using the above-described primary and secondary synchronization signals.

Then, a sequence corresponding to synchronization signals depicted in FIG. 13 and FIG. 14 will be explained. In this case, a slot structure may adopt the structure depicted in FIG. 9 and FIG. 10, and a structure of an OFDM symbol may adopt the structure depicted in FIG. 13 and FIG. 14.

First, the length of the primary synchronization signal is 62 as represented in a below equation 10, and Zadoff-Chu sequences, which are identical to those of the LTE system, may be used for the primary synchronization signal as described below. It is not necessary that u is selected identically to the LTE case. u may be three discriminable values, which are discriminated from each other and selected among values from 0 to 62.

$${p}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix} \qquad [ Equation 10 ]$$

A terminal may identify u by detecting the primary synchronization signal defined in the equation 10 in a first stage, and detect a boundary of 2 ms frame.

A second stage is performed by using a secondary synchronization signal, and a sequence for the secondary synchronization signal may be defined as below equation 11.

d(n)=s^{m}^{ᵢ}(n) in Slot 8i+7 (or 1) and i=0, 1, . . . , 4

s^{(m}^{ᵢ}⁾=\tilde{s}((n+mᵢ)mod 62)

\tilde{s}=1−2x(i), 0≦i≦61 [Equation 11]

x(i) is a m-sequence generated using a polynomial x⁶+x+1 and an initial condition x(0)=0,x(1)=0,x(2)=0,x(3)=0,x(4)=0,x(5)=1. A sequence \tilde{s} is a sequence converted to −1 or 1 from x(i), and is cyclic-shifted by mᵢ, so that it becomes s^{(m}^{ᵢ}⁾. Also, mᵢ is a hopping code according to the present invention, and is a hopping code satisfying a hamming distance of 4 in this example.

In this example, since the length of the sequence is 62, a single m-sequence may be used. At this time, a degree of the polynomial for generating the m-sequence may be 6. The method for generating the sequence using the above polynomial may be represented as below equation 12.

x(i+6)=(x(i+1)+x(i))mod 2, 0≦i≦55 [Equation 12]

In the equation 12, an operation (mod 2) outputs a remainder of division by 2. mᵢ is a hopping code, and may be defined as 5 values {m₀, m₁, . . . , m₄} each of which corresponds to first cell information N_{ID}⁽¹⁾=0, 1, . . . , 167, a cell-specific value, in one-to-one manner.

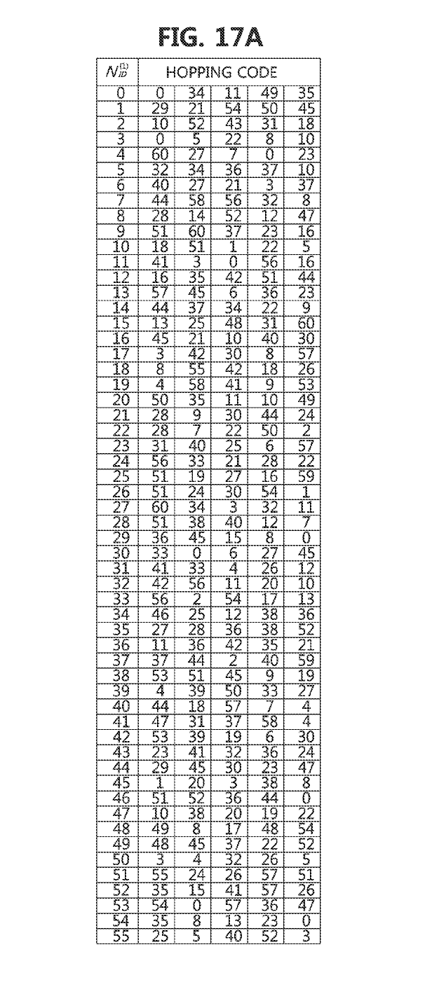

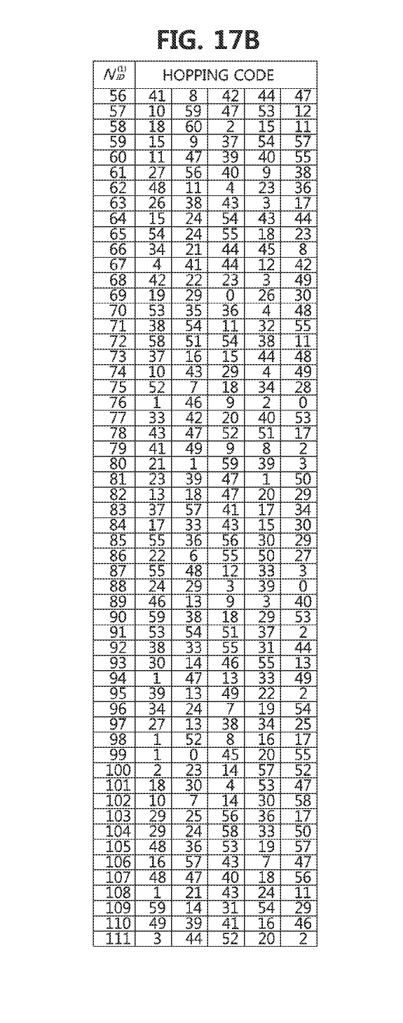

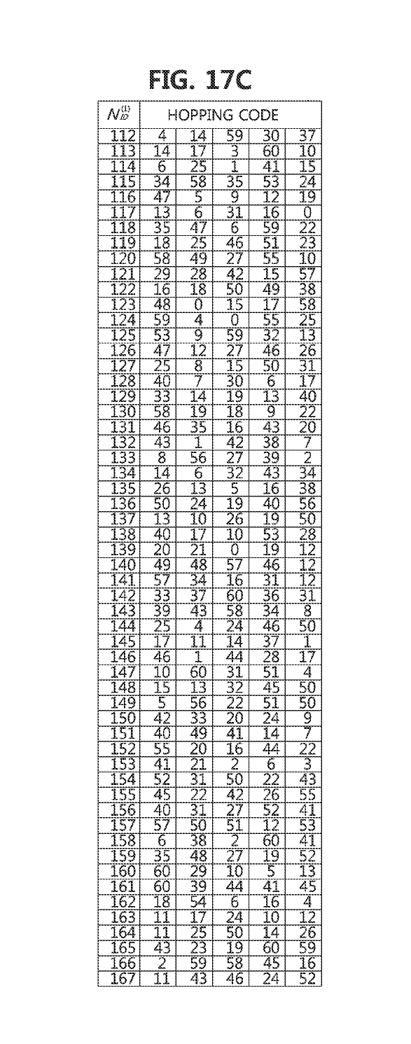

FIGS. 17A to 17C are views illustrating another example embodiment of hopping codes satisfying a hamming distance of 4.

Values represented in FIGS. 17A to 17C are computer-generated random numbers for a case that Alphabet size is 62 and a length of hopping code is 5. The number of sets of such the random numbers is larger than 168, and values represented in FIGS. 17A to 17C are values selected among the sets.

If a terminal identified a boundary of 2 ms by using the primary synchronization signal, the terminal may identify a boundary of 10 ms by using the secondary synchronization signal defined in example embodiments of FIG. 11 and FIGS. 17A to 17C. The difference between the example embodiment of FIGS. 16A to 16C and the example embodiment of FIGS. 17A to 17C is that Alphabet size is 62 for the latter example embodiment. That is, the value used for a hopping code is a value ranged from 0 to 61.

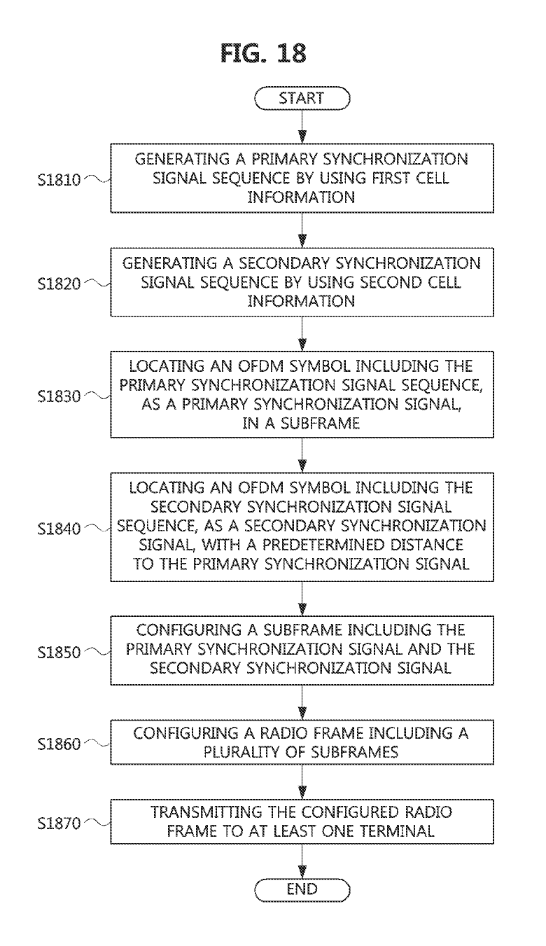

FIG. 18 is a flow chart illustrating a method for configuring a frame according to an example embodiment of the present invention.

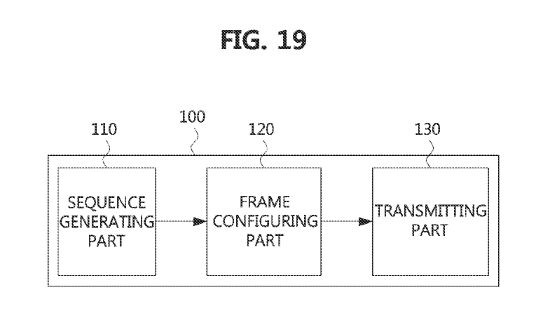

In the descriptions of the example embodiment below, each step of a method for configuring a frame according to the present invention may be understood as an operation performed in a corresponding element in a base station described with reference to FIG. 19, however the individual steps of the method should only be limited by their own functions by which they are defined. That is, the entities performing the steps are not limited by the names of entities illustrated as performing the steps in the examples.

For convenience of explanation, it is supposed that the entity performing the method depicted in FIG. 18 is a base station.

According to a method for configuring a frame according to an example embodiment of the present invention, a base station may generate a primary synchronization signal sequence by using first cell information (S1810), and generate a secondary synchronization signal sequence by using second cell information (S1820). Here, the second cell information may be a value corresponding to a hopping code according to the present invention, and the secondary synchronization sequence may be generated according to the hopping code determined based on the second cell information.

Then, the base station may locate an OFDM symbol including the primary synchronization signal sequence one by one in a subframe as a primary synchronization signal (S1830). At this time, spacing between synchronization signals may not be one subframe. That is, the spacing between synchronization signals may be two subframes or three subframes.

Also, the base station may locate an OFDM symbol including the secondary synchronization signal sequence with a predetermined distance from the primary synchronization signal as the secondary synchronization signal (S1840). According to the preferred example embodiment of the present invention, the secondary synchronization signal may be located in a temporally previous symbol of the symbol in which the primary synchronization signal is located.

Then, the base station may configure a subframe including the primary synchronization signal and the secondary synchronization signal (S1850), and configure a radio frame comprising a plurality of subframes (S1860). The base station may transmit the configured frame to at least one terminal (S1870).

FIG. 19 is a block diagram illustrating a base station according to an example embodiment of the present invention.

A base station 100 according to the present invention may comprise a sequence generating part 110, a frame configuration part 120, and a transmitting part 130.

The sequence generating part 110 may generate a primary synchronization signal sequence by using first cell information, and generate a secondary synchronization signal sequence by using second cell information.

The frame configurating part 120 may configure a frame using the generated primary and secondary synchronization signal sequences. Specifically, the frame configurating part 120 may locate an OFDM symbol including the primary synchronization sequence in a frame as a primary synchronizations signal, and may locate an OFDM symbol including the secondary synchronization sequence in the frame as a secondary synchronization signal. The secondary synchronization signal may be located with a predetermined distance from the primary synchronization signal. Then, the frame configurating part 120 may configure the frame including the primary and secondary synchronization signals.

The radio frame which is configured as described above may be transmitted to at least one terminal through the transmitting part 130.

The above-described components are classified functionally rather than physically, and may be defined by functions performed by each component. Each component may be implemented by hardware and/or a program code and a processing unit which perform each function, and implemented in such a manner that functions of at least two components are included in a single component.

Therefore, in the following embodiments, names given to components are given to imply a representative function performed by each component rather than physical separation, and it should be noted that the technical spirit of the present invention is not limited by the names of components.

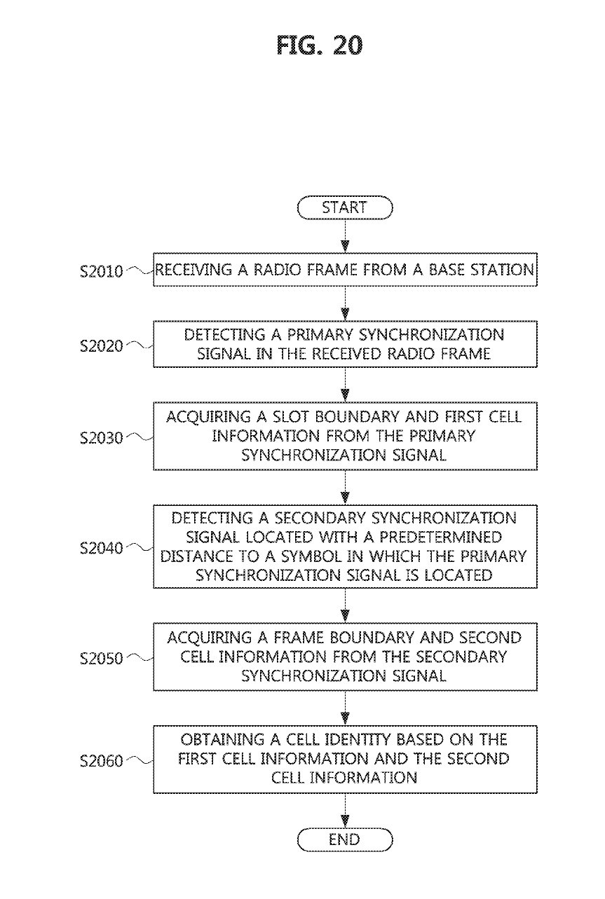

FIG. 20 is a flow chart illustrating a method for a mobile terminal to acquire synchronization according to an example embodiment of the present invention.

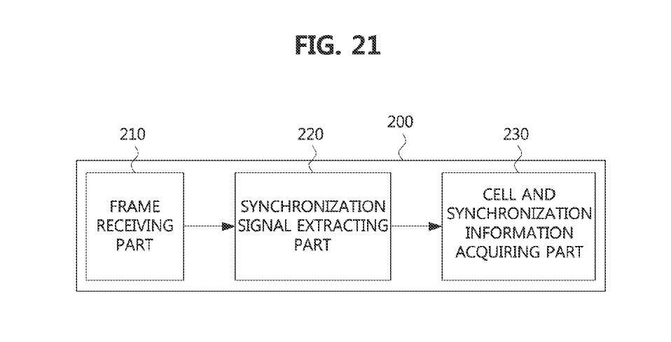

In descriptions of the example embodiment below, each step of a method for acquiring synchronization according to the present invention may be understood as an operation performed in a corresponding element in a mobile terminal described with reference to FIG. 21, however the individual steps of the method should only be limited by their own functions by which they are defined. That is, the entities performing the steps are not limited by the names of entities illustrated as performing the steps in the examples.

A terminal may receive a radio frame from a base station (S2010), and detect a primary synchronization signal in the received radio frame (S2020). The terminal may detect a slot boundary and first cell information from the detected primary synchronization signal (S2030). After detecting the primary synchronization signal, the terminal may detect a secondary synchronization signal located in a predetermined position from a symbol in which the primary synchronization signal is located (S2040).

The terminal may detect a frame boundary and second cell information from the detected secondary synchronization signal sequence (S2050). Here, the step of acquiring the second cell information may comprise a step of extracting secondary synchronization sequence included in the secondary synchronization signal for a plurality of subframes, a step of comparing the extracted plurality of secondary synchronization sequences with a predefined hopping code table, and a step of acquiring second cell information according to a hopping code which is matched to the plurality of secondary synchronization sequences.

At this time, the step of extracting secondary synchronization sequence included in the secondary synchronization signal may be performed for as many number of secondary synchronization signals as determined according to hamming distances which hopping codes included in the hopping code table have.

That is, according to hopping codes used in a system, at least two or three continuous secondary synchronization sequences are compared. For example, when a length of a hopping code used in the system is 5, two sequences are compared. When a length of a hopping code used in the system is 10, three sequences are compared.

If the hopping code is acquired, second cell information may be obtained. Also, the terminal may obtain a cell identity by using the first cell information and the second cell information (S2060).

FIG. 21 is a block diagram illustrating a mobile terminal according to an example embodiment of the present invention.

A mobile terminal depicted in FIG. 21 may comprise a frame receiving part 210, a synchronization signal extracting part 220, a cell and synchronization information acquiring part 230.

The frame receiving part 210 may receive a radio frame transmitted from a base station.

The synchronization signal extracting part 220 may detect a primary synchronization signal in the received radio frame, and detect a secondary synchronization signal located in a predetermined position from a symbol in which the primary synchronization signal is located.

The cell and synchronization information acquiring part 230 may extract a slot boundary and first cell information from the detected primary synchronization signal, and extract a frame boundary and second cell information from the secondary synchronization signal.

Here, the cell and synchronization information acquiring part 230 may extract secondary synchronization sequence included in the secondary synchronization signal for a plurality of subframes to extract second cell information, compare the extracted plurality of secondary synchronization sequences with a predefined hopping code table, and acquire second cell information according to a hopping code which is matched to the plurality of secondary synchronization sequences. If the hopping code is acquired, second cell information may be obtained. Also, the cell and synchronization information acquiring part 230 may obtain a cell identity by using the first cell information and the second cell information.

The above-described components are classified functionally rather than physically, and may be defined by functions performed by each component. Each component may be implemented by hardware and/or a program code and a processing unit which perform each function, and implemented in such a manner that functions of at least two components are included in a single component.

Therefore, in the following embodiments, names given to components are given to imply a representative function performed by each component rather than physical separation, and it should be noted that the technical spirit of the present invention is not limited by the names of components.

As described above, a frame structure and a synchronization signal structure suitable for the frame structure, which can be used for a mobile communication system using millimeter-wave, especially using an OFDM, were proposed through the example embodiments according to the present invention. Since a space between subcarriers is enlarged and a length of OFDM symbols is changed as compared to those of conventional cellular communication band, a frame structure should be changed. Also, a synchronization signal structure optimized for the changed frame structure becomes necessary. In order to perform acquisition of synchronization by two-step procedure, a primary synchronization signal and a secondary synchronization signal are located.

Especially, according to a synchronization signal structure of the secondary synchronization signal, complexity of implementation may be reduced by using hopping codes satisfying hamming distances of 4 or 8. In the case of LTE, since scrambling code in addition to a basic sequence is multiplied, complexity increases.

In the present invention, example embodiments of hopping patterns having a length of 10 (hamming distance of 8) or 5 (hamming distance of 4) are proposed, and it is described that a boundary of 10 ms could be identified by detecting signal for minimum 3 μs (corresponding to three secondary synchronization signals) or 4 μs (corresponding to two secondary synchronization signals).

In brief, the present invention provides a synchronization signal structure suitable for millimeter wave and a design of synchronization signal sequences having low complexity.

As described above, according to the present invention, a structure of a synchronization signal suitable for millimeter-waves may be achieved. Also, the present invention provides a low-complexity synchronization signal sequences so that a complexity of a receiving apparatus which receives the synchronization signal may be reduced.

While the example embodiments of the present invention and their advantages have been described in detail, it should be understood that various changes, substitutions and alterations may be made herein without departing from the scope of the invention.

What is claimed is:

1. A method for configuring a radio frame used in a mobile communication system, the method comprising:
generating a first synchronization signal and locating the first synchronization signal in a slot for synchronization signal;
generating a second synchronization signal and locating the second synchronization signal in a predetermined position from the first synchronization signal; and
configuring a radio frame including the first synchronization signal and the second synchronization signal,
wherein the mobile communication system is a mobile communication system using a millimeter wave frequency band, and a space between symbols used in the mobile communication system is one-tenth of a space between symbols used in a Long Term Evolution (LTE) system.

2. The method of claim 1, wherein the primary synchronization signal and the secondary synchronization signal are located in a symbol allocated for downlink, and located as not overlapped with a control channel.

3. The method of claim 1, wherein the primary synchronization signal and the secondary synchronization signal are located in a symbol adjacent to a symbol for a broadcast channel.

4. The method of claim 1, wherein the secondary synchronization signal is located in a previous symbol of a symbol in which the primary synchronization signal is located.

5. The method of claim 1, wherein the primary synchronization signal is located in a last symbol of a slot in which the primary synchronization signal is located.

6. The method of claim 1, wherein a plurality of the primary synchronization signals located in a frame include a same sequence.

7. The method of claim 1, wherein a plurality of the secondary synchronization signals located in a frame are different to each other.

8. The method of claim 1, wherein a sequence for the primary synchronization signal and a sequence for the secondary synchronization signal are transmitted through a half band of a synchronization signal band located in a center of the synchronization signal band, and transmitted with double power as compared to a case in which they are transmitted through the whole synchronization signal band.

9. The method of claim 7, wherein a plurality of secondary synchronization signal sequences included in a frame are different sequences derived from a same sequence, and constitute hopping code with a predetermined hamming distance.

10. A method of acquiring synchronization, performed in a mobile terminal, the method comprising:
receiving a radio frame including a plurality of time slots;
detecting a first synchronization signal included in the radio frame by searching the radio frame; and
detecting a second synchronization signal included in the radio frame, located with a predetermined distance from the first synchronization signal,
wherein the radio frame is received from a mobile communication system using a millimeter wave frequency band, and a distance between symbols used in the mobile communication system is one-tenth of a distance between symbols used in a Long Term Evolution (LTE) system.

11. The method of claim 10, further comprising acquiring a slot boundary based on the detected primary synchronization signal, wherein the radio frame includes a plurality of subframes each of which includes a plurality of slots.

12. The method of claim 10, further comprising acquiring a radio frame boundary based on the detected secondary synchronization signal.

13. The method of claim 10, further comprising:
obtaining first cell information from the detected primary synchronization signal;
obtaining second cell information from the detected secondary synchronization signal; and
deriving a cell identity of a base station based on the first cell information and the second cell information.

14. The method of claim 10, wherein a plurality of secondary synchronization signal sequences included in a frame are different sequences derived from a same sequence, and constitute hopping code with a predetermined hamming distance.

15. The method of claim 13, wherein the obtaining second cell information comprises:
extracting a plurality of secondary synchronization signal sequences included in a plurality of secondary synchronization signals;
comparing the extracted plurality of secondary synchronization signal sequences with a predefined hopping code table; and
obtaining the second cell information according to a hopping code matched to the extracted plurality of secondary synchronization signal sequences.

16. The method of claim 15, wherein the hopping code table includes a plurality of hopping codes each of which corresponds to one of a plurality of second cell information.

17. The method of claim 16, wherein the extracting a plurality of secondary synchronization signal sequences is performed for as many number of secondary synchronization signals as determined according to a hamming distance which the hopping codes included in the hopping code table have.

18. A method for generating a synchronization signal for a mobile communication, the method comprising:
generating a first synchronization sequence by using a first cell information; and
generating a second synchronization sequence by using a second cell information,
wherein a plurality of second synchronization sequences included in a radio frame constitute a hopping code having a predetermined hamming distance.

19. The method of claim 18, wherein a plurality of secondary synchronization signal sequences included in a frame are different sequences derived from a same sequence, and constitute hopping code with a predetermined hamming distance

20. The method of claim 18, wherein a plurality of the primary synchronization signal sequences included in a frame are a same sequence.
